(19) United States
(12) Patent Application Publication
(10) Pub. No.: US 2020/0174707 A1
(43) Pub. Date: Jun. 4, 2020

(54) FIFO FILLING LOGIC FOR TENSOR CALCULATION

(71) Applicant: Wave Computing, Inc., Santa Clara, CA (US)

(72) Inventor: Stephen Curtis Johnson, Morgan Hill, CA (US)

(21) Appl. No.: 16/784,363

(22) Filed: Feb. 7, 2020

Related U.S. Application Data
(63) Continuation-in-part of application No. 16/170,268, filed on Oct. 25, 2018.
(60) Provisional application No. 62/907,907, filed on Sep. 30, 2019.
(60) Provisional application No. 62/898,770, filed on Sep. 11, 2019.
(60) Provisional application No. 62/898,114, filed on Sep. 10, 2019.
(60) Provisional application No. 62/893,970, filed on Aug. 30, 2019.
(60) Provisional application No. 62/894,002, filed on Aug. 30, 2019.
(60) Provisional application No. 62/887,713, filed on Aug. 16, 2019.
(60) Provisional application No. 62/887,722, filed on Aug. 16, 2019.
(60) Provisional application No. 62/882,175, filed on Aug. 2, 2019.
(60) Provisional application No. 62/874,022, filed on Jul. 15, 2019.
(60) Provisional application No. 62/857,925, filed on Jun. 6, 2019.
(60) Provisional application No. 62/856,490, filed on Jun. 3, 2019.
(60) Provisional application No. 62/850,059, filed on May 20, 2019.
(60) Provisional application No. 62/827,333, filed on Apr. 1, 2019.
(60) Provisional application No. 62/802,307, filed on Feb. 7, 2019.
(60) Provisional application No. 62/694,984, filed on Jul. 7, 2018.
(60) Provisional application No. 62/692,993, filed on Jul. 2, 2018.
(60) Provisional application No. 62/679,046, filed on Jun. 1, 2018.
(60) Provisional application No. 62/679,172, filed on Jun. 1, 2018.
(60) Provisional application No. 62/650,425, filed on Mar. 30, 2018.
(60) Provisional application No. 62/650,758, filed on Mar. 30, 2018.
(60) Provisional application No. 62/637,614, filed on Mar. 2, 2018.
(60) Provisional application No. 62/636,309, filed on Feb. 28, 2018.
(60) Provisional application No. 62/611,600, filed on Dec. 29, 2017.
(60) Provisional application No. 62/611,588, filed on Dec. 29, 2017.
(60) Provisional application No. 62/594,563, filed on Dec. 5, 2017.
(60) Provisional application No. 62/594,582, filed on Dec. 5, 2017.
(60) Provisional application No. 62/579,616, filed on Oct. 31, 2017.
(60) Provisional application No. 62/577,902, filed on Oct. 27, 2017.

(51) Int. Cl. G06F 3/06

(52) U.S. Cl. CPC G06F 3/0659; G06F 3/0673; G06F 3/061

(57) ABSTRACT

Techniques for data manipulation using filling logic for tensor calculation are disclosed. A processor and a memory subsystem for data manipulation are obtained. A FIFO is configured between the processor and the memory subsystem, where the FIFO is coupled with the processor. FIFO filling logic is configured between the FIFO and the memory subsystem, wherein the FIFO filling logic is connected to the FIFO and the memory subsystem. The processor consumes an element stream from the FIFO, wherein the element stream flows to the FIFO from the memory subsystem through the FIFO filling logic. The element stream from the FIFO comprises elements of a tensor, and the consuming comprises performing tensor calculations. An address is provided to the FIFO filling logic for accessing data from the memory subsystem using an address generator.

### RELATED APPLICATIONS

This application claims the benefit of U.S. provisional patent applications “FIFO Filling Logic for Tensor Calculation” Ser. No. 62/802,307, filed Feb. 7, 2019, “Matrix Multiplication Engine Using Pipelining” Ser. No. 62/827,333, filed Apr. 1, 2019, “Dispatch Engine with Queuing and Scheduling” Ser. No. 62/850,059, filed May 20, 2019, “Artificial Intelligence Processing Using Reconfiguration and Tensors” Ser. No. 62/856,490, filed Jun. 3, 2019, “Dispatch Engine with Interrupt Processing” Ser. No. 62/857,925, filed Jun. 6, 2019, “Data Flow Graph Computation Using Barriers with Dispatch Engines” Ser. No. 62/874,022, filed Jul. 15, 2019, “Integer Multiplication Engine Using Pipelining” Ser. No. 62/882,175, filed Aug. 2, 2019, “Multidimensional Address Generation for Direct Memory Access” Ser. No. 62/887,713, filed Aug. 16, 2019, “Processor Cluster Dispatch Engine with Dynamic Scheduling” Ser. No. 62/887,722, filed Aug. 16, 2019, “Data Flow Graph Computation Using Barriers” Ser. No. 62/893,970, filed Aug. 30, 2019, “Data Flow Graph Computation with Barrier Counters” Ser. No. 62/894,002, filed Aug. 30, 2019, “Distributed Dispatch Engine for Use with Heterogeneous Accelerators” Ser. No. 62/898,114, filed Sep. 10, 2019, “Data Flow Processing Dispatch Graph Compilation” Ser. No. 62/898,770, filed Sep. 11, 2019, and “Processor Cluster Address Generation” Ser. No. 62/907,907, filed Sep. 30, 2019.

This application is also a continuation-in-part of U.S. patent application “Tensor Manipulation Within a Neural Network” Ser. No. 16/170,268, filed Oct. 25, 2018, which claims the benefit of U.S. provisional patent applications “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to data manipulation and more particularly to FIFO filling logic for tensor calculation.

### BACKGROUND

Collection of personal and other data is commonplace and sometimes goes unnoticed. The data is widely collected from people as they interact with their electronic devices. Whether an individual is using her smartphone to peruse world news headlines, or another person is using his tablet to order pet food, metadata about their device usage is collected. Data and metadata relating to websites visited, products and services searched or viewed, and radio buttons clicked are collected and analyzed, frequently for the purpose of monetization. The data is used to push online content, products, or services that are predicted to match user interest. The collection of personal and other data is ever increasing due to emerging software analysis techniques and processor architectures. Governments, researchers, and businesspeople gather the collected data into datasets, which are often referred to as “big data”. The big data dataset can then be analyzed. The analysis of big data is not economically feasible using general purpose or traditional computational techniques and processors, because the sizes of datasets saturate the capabilities of the processors and analysis techniques traditionally utilized. The computational and processing requirements are further complicated by data manipulations such as the access, capture, maintenance, storage, transmission, and visualization of the data, among other tasks, any of which quickly swamp the capacities of the traditional systems. The collected data essentially would be of little or no value to any stakeholders without viable and scalable data analysis and handling techniques that are capable of meeting the requirements and applications of the data. Innovative computing architectures, plus software techniques, algorithms, functions, routines, and heuristics, are demanded. Dataset owners or those who have access to the datasets are highly motivated by business and research demands to analyze the data contained within. The purposes of data analysis can include business analysis; disease or infection detection, tracking, and control; crime detection and prevention; meteorology; and complex science and engineering simulations, to name but a very few. Advanced data analysis techniques are finding applications such as predictive analytics which can show consumers what they want, even before the consumers know they want it. Additional approaches include applying machine learning and deep learning techniques in support of the data analysis.

The advent of improved processors and learning techniques has expanded and benefited computer science disciplines including machine learning and many others. Machine learning contends that a machine can “learn” about a unique dataset, without the machine having to be explicitly coded or programmed by a user to handle that dataset. Machine learning can be performed on a network such as a neural network. The neural network can process the big data datasets in order for the neural network to learn. The greater the quantity of data, and the higher the quality of the data that is processed, the better the outcome of the machine learning. The processors on which the machine learning techniques can be executed are designed to efficiently handle the flow of data. These processors, which are based on data flow architectures, process data when valid data becomes available. This allows for helpful simplifications and in some cases avoids a need for a global system clock.

Reconfigurable hardware is a highly flexible and advantageous computing architecture that is well suited to processing large data sets, performing complex computations, and executing other computationally resource-intensive applications. Reconfigurable computing integrates the key features of hardware and software techniques. A reconfigurable computing architecture can be “recoded” (reprogrammed). The recoding adapts or configures the high-performance hardware architecture, much like recoding software. A reconfigurable fabric hardware technique is directly applicable to reconfigurable computing. Reconfigurable fabrics may be arranged in configurations or topologies for the many applications that require high performance computing. Applications such as processing of big data, digital signal processing (DSP), machine learning based on neural networks, matrix or tensor computations, vector operations, Boolean manipulations, and so on, can be implemented within a reconfigurable fabric. The reconfigurable fabric operates particularly well when the data can include specific types of data, large quantities of unstructured data, sample data, and the like. The reconfigurable fabrics can be coded or scheduled to achieve these and other processing techniques, and to represent a variety of efficient computer architectures.

### SUMMARY

The processing of vast quantities of data such as unstructured data is widely applicable. The data, which is collected into large datasets or “big data”, is processed for applications in areas such as artificial intelligence, trend analysis, business analytics, machine learning (including deep learning), medical research, law enforcement, public safety, and so on. Traditional processors and processing techniques for data analysis fall far short of the voluminous data handling requirements. Data analysis systems designers and engineers have tried to meet the processing requirements by building or purchasing faster processors, designing custom integrated circuits (chips), implementing application specific integrated circuits (ASICs), programming field programmable gate arrays (FPGAs), etc. These approaches are based on computer and chip architectures, such as Von Neumann architectures, which are focused on how control of the chip operations (control flow view) is performed. Alternatively, the flow of data (data flow view) can be considered. In a data flow architecture, the execution of instructions, functions, subroutines, kernels, agents, apps, etc. is based on the presence or absence of valid data which is available to a processor. This latter approach, that of a data flow architecture, is far better suited to the tasks of handling the large amounts of unstructured data that is processed as part of the machine learning and deep learning applications. The data flow architecture obviates the need for centralized control of the processing since no system clocks or centralized control signals are required. A data flow architecture can be implemented using a reconfigurable fabric.

Data manipulation is based on FIFO filling logic for tensor calculation. A processor-implemented method for data manipulation is disclosed comprising: obtaining a processor and a memory subsystem for data manipulation; configuring a FIFO between the processor and the memory subsystem, wherein the FIFO is coupled with the processor; configuring FIFO filling logic between the FIFO and the memory subsystem, wherein the FIFO filling logic is connected to the FIFO and the memory subsystem; and consuming, by the processor, an element stream from the FIFO, wherein the element stream flows to the FIFO from the memory subsystem through the FIFO filling logic. In embodiments, the element stream from the FIFO comprises elements of a tensor. The elements of the tensor can include small submatrices associated with the tensor. The consuming by the processor includes performing tensor operations. Other operations such as logical operations or mathematical operations can be performed. An address is provided to the FIFO filling logic by an address generator. The address from the address generator enables memory subsystem access. In embodiments, the address generator enables multi-dimensional tensor access by overlapped striding through the multi-dimensional tensor. The overlapped striding enables submatrices of a tensor to overlap. Based on the overlapped striding, redundant data can be loaded into the FIFO. Loading the FIFO with redundant data obviates the need to access the memory subsystem for data used by overlapping submatrices.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for FIFO filling logic for tensor calculation.

FIG. 2 is a flow diagram for data-dependent branchless instructions.

FIG. 3A shows a processor and memory subsystem with cache control.

FIG. 3B shows a data access using FIFO filling logic.

FIG. 4A illustrates address generation structure.

FIG. 4B illustrates address generation logic.

FIG. 5A shows data matrices with overlapped striding.

FIG. 5B shows transposed data matrices with striding.

FIG. 6 shows a server allocating FIFOs and processing elements.

FIG. 7 shows a cluster for coarse-grained reconfigurable processing.

FIG. 8 illustrates a block diagram of a circular buffer.

FIG. 9 shows a circular buffer and processing elements.

FIG. 10 illustrates a deep learning block diagram.

FIG. 11 is a system diagram for data manipulation.

### DETAILED DESCRIPTION

Techniques for data manipulation based on FIFO filling logic are disclosed. The FIFO filling logic can comprise a processor and a memory subsystem. The FIFO can provide an element stream to a processor, where the elements of the element stream include elements of a tensor. The elements can include small data submatrices of a tensor. The elements of the element stream need not be unique. The disclosed techniques take advantage of tensor calculations for which a submatrix can overlap other submatrices. Rather than forcing a processor to waste processing cycles waiting for overlapped or redundant data to be fetched from a memory subsystem, the redundant data can be loaded into the FIFO along with the data. The processor can proceed with processing both the data and the redundant data without the data fetch delays. The disclosed techniques describe applications of the processor and memory subsystem. In embodiments, the processor and memory subsystem can be used to implement a data flow graph, where the data flow graph can implement machine learning.

The processor can include a CPU or GPU, programmable logic, application-specific integrated circuits (ASICs), arithmetic processors, and the like. The processor can include clusters of elements within a reconfigurable computing environment. The memory subsystem can include small, fast memory and large, slow memory. The memory can include DMA memory, high performance memory, etc. While the disclosed techniques can address tensor calculations, the techniques can further be applied to processing of data using functions, algorithms, heuristics, apps, etc. The processing of data for data manipulation can be used to process large datasets. The large amounts of data, or “big data”, overwhelm conventional, control-based computer hardware techniques such as Von Neumann techniques. The tensor calculations, functions, algorithms, heuristics, and so on, instead can be described using data flow graphs, agents, networks, and so on. The data flow graphs, agents, networks, etc. can be decomposed or partitioned into smaller operations such as kernels. The kernels can be allocated to processors such as CPUs or GPS, or to elements of the reconfigurable fabric. The allocating of elements within the reconfigurable fabric can include single processing elements, clusters of processing elements, a plurality of clusters of processing elements, co-processors, etc. The reconfigurable fabric includes elements that can be configured as processing elements, switching elements, storage elements, and so on. The configuring of the elements within the reconfigurable fabric, and the operation of the configured elements, can be controlled by rotating circular buffers. The rotating circular buffers can be coded, programmed, or “scheduled” to control the elements of the reconfigurable array. The rotating circular buffers can be statically scheduled. The reconfigurable fabric supports data transfer, communications, and so on. The reconfigurable fabric further includes ports such as input ports, output ports, and input/output (bidirectional) ports, etc., which can be used to transfer data both into and out of the reconfigurable fabric.

In a reconfigurable fabric, mesh network, distributed network, or other suitable processing topology, the multiple processing elements (PEs) obtain data, process the data, store data, transfer data to other processing elements, and so on. The processing that is performed can be based on kernels, agents, functions, etc., which include sets of instructions that are allocated to a single PE, a cluster of PEs, a plurality of clusters of PEs, etc. The clusters of PEs can be distributed across the reconfigurable fabric. In order for processing of the data to be performed effectively and efficiently, the data must be routed from input ports of the reconfigurable fabric, through the reconfigurable fabric, to the clusters of PEs that require the data. A FIFO can be used to provide an element stream to the processors, processing elements, and so on, that require the data. The element stream can include data, elements of a matrix or array, elements of a tensor, and so on. The FIFO provides the element stream based on FIFO filling logic for tensor calculation.

FIFO filling logic for tensor calculation includes data manipulation. A processor and a memory subsystem for data manipulation are obtained. The processor and memory subsystem can include clusters of elements allocated within a reconfigurable fabric. The elements of the reconfigurable fabric can include processing elements, storage elements, or switching elements. A FIFO is configured between the processor and the memory subsystem, where the FIFO is coupled with the processor. The FIFO can include a depth, where the depth can be dependent on processor speed, memory subsystem access speed, and so on. FIFO filling logic is configured between the FIFO and the memory subsystem, where the FIFO filling logic is connected to the FIFO and the memory subsystem. An address is provided to the FIFO filling logic for accessing data from the memory subsystem using an address generator. The address generator enables multi-dimensional tensor access by overlapped striding through the multi-dimensional tensor. The processor consumes an element stream from the FIFO, where the element stream flows to the FIFO from the memory subsystem through the FIFO filling logic. The element stream from the FIFO includes elements of a tensor. The consuming comprises performing tensor calculations, where the tensor calculations can include multiplication, contraction, index raising, index lowering, convolution, filtering, and so on. In embodiments, multiple element streams from multiple FIFOs are configured to supply elements to the processor. In embodiments, a stream of tensor data elements is provided using a different accessing methodology, for example, row-based accesses vs. column-based accesses, without disturbing the tensor as stored in memory.

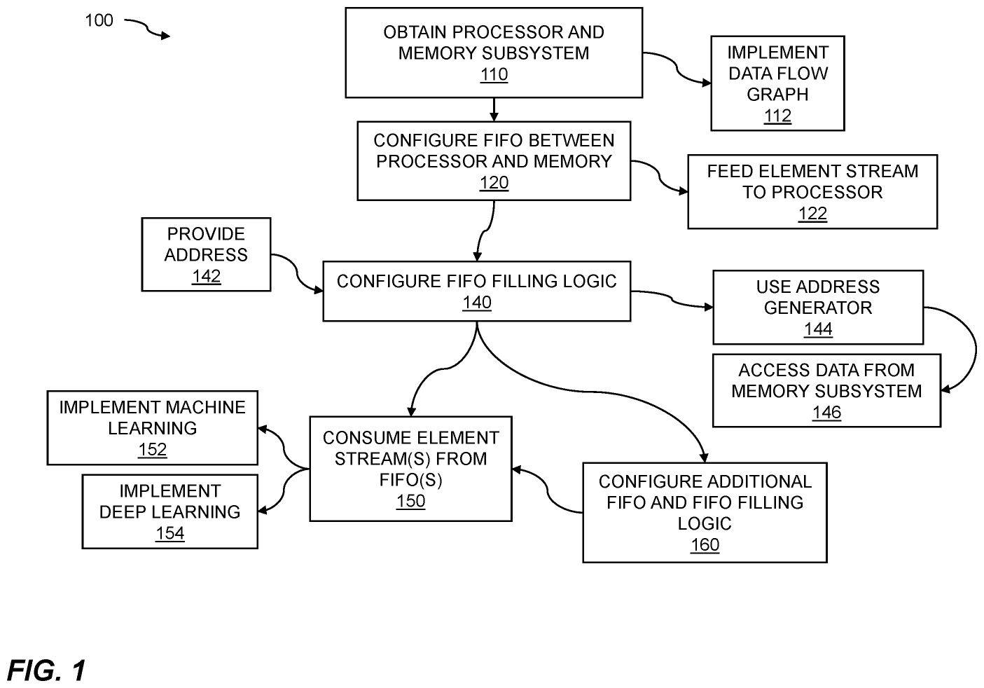

FIG. 1 is a flow diagram for FIFO filling logic for tensor calculation. A FIFO can be used to provide data, such as tensor data, multi-dimensional data, or other data to a processor. The tensor calculation can include a tensor product, a tensor contraction, raising a tensor index, lowering a tensor index, and so on. The tensor can be represented by an array, a matrix, submatrices, etc. The flow 100 includes obtaining a processor and a memory subsystem 110 for data manipulation. The processor and the memory subsystem can include one or more processors such as central processing units (CPUs), graphic processing units (GPUs), arithmetic processors, multiplication processors, reconfigurable processors such as array or parallel processors, reconfigurable integrated circuits or chips such as field programmable gate arrays (FPGAs), application-specific integrated circuits (ASICs), and so on. The memory subsystem can include various types of memory, where the memory can include fast memory, slow memory, and the like. In embodiments, the memory subsystem comprises DMA memory. The DMA memory can include remote DMA memory. In other embodiments, the memory subsystem comprises high performance memory (HPM). The high performance memory can be smaller and faster than the slower memory. In embodiments, the processor and memory subsystem can be allocated as part of one or more clusters within a reconfigurable fabric. The one or more clusters comprise elements that can be configured. In embodiments, each cluster of the one or more clusters within the reconfigurable fabric can include processing elements, switching elements, or storage elements. In order to configure the reconfigurable fabric, the clusters can be controlled by a code, a program, a schedule, and so on. In embodiments, each cluster of the one or more clusters within the reconfigurable fabric can be controlled by one or more circular buffers. A code, program, or schedule can be loaded into the one or more circular buffers. In embodiments, the one or more circular buffers are statically scheduled.

The processor and memory subsystem can be configured and used for a variety of computational purposes. The processor and memory subsystem can be configured to perform operations such as logic operations, mathematical operations, array or matrix operations, tensor operations, and so on. The operations that can be performed can be represented by graphs, networks, nets, and so on. In embodiments, the processor and memory subsystem is used to implement a data flow graph 112. A data flow graph can be represented by kernels, agents, codes, routines, procedures, etc. In embodiments, the data flow graph implements machine learning. The machine learning can be used to analyze data and to adapt based on the data, where the adapting can increase accuracy, improve convergence of the computations, and the like. In embodiments, the machine learning utilizes one or more neural networks. Various neural network techniques can be used to implement the one or more neural networks. In embodiments, the techniques used to implement the one or more neural networks can include convolutional neural networks, recurrent neural networks, and so on.

The flow 100 includes configuring a FIFO between the processor and the memory subsystem 120, where the FIFO is coupled with the processor. The FIFO can be used to provide data to the processor. The FIFO can act as a buffer between the memory subsystem in the processor, where data can be received from the memory subsystem based on memory access speeds, and where the processor can consume the data based on processing speeds. The data within the FIFO can include elements of an array or matrix, tensor data, multi-dimensional tensor data, and so on. The size of the FIFO can be chosen based on memory subsystem access times, processor data consumption speeds, data storage requirements, etc. In embodiments, the FIFO can be at least 128 elements deep. FIFOs including other element depths can be used. In embodiments, the FIFO can be used to feed a data element stream to the processor 122. The data element steam can include various types of data such as tensor data. In embodiments, the data elements provide input for a dot product operation. A dot product operation can be performed between arrays, matrices, submatrices, etc. In embodiments, the flow 100 includes supplying weights for the dot product operation through an input path to the processor, different from an input supplied by the FIFO. The path which is different from the input path supplied by the FIFO can include a data port, DMA access, etc. The path can include reading the weights for the dot production operation from a file, downloading the weights over a computer network, etc.

The flow 100 includes configuring FIFO filling logic 140 between the FIFO and the memory subsystem, where the FIFO filling logic is connected to the FIFO and the memory subsystem. The FIFO filling logic can provide data such as tensor data to the FIFO. The FIFO filling logic can have a depth, where the depth can be dependent on memory subsystem access speed, the size of the FIFO, and so on. In embodiments, the FIFO filling logic can be 1024 elements deep. Other element depths can be chosen or designed for the FIFO filling logic. The flow 100 further includes providing an address 142 to the FIFO filling logic, or FIFO filler pipe, for accessing data from the memory subsystem using an address generator 144. The address can be used to access one or more memories associated with the memory subsystem 146. The one or more memories can include fast memory or slow memory. The fast memory and the slow memory can include different sizes of memory. The address generator can generate an address based on the type of data to be retrieved from the memory subsystem. The type of data can include elements of an array, a matrix, a tensor, a multi-dimensional tensor, etc. In embodiments, the FIFO filling logic can use the address generator to enable loading of small submatrices of a tensor stored in the memory subsystem into the FIFO for use by the processor. The address generator can include hardware or software. In embodiments, the address generator can include a second processor. The second processor can include allocated clusters of elements within a reconfigurable fabric. The FIFO filling logic can provide data, redundant data, overlapped data, and so on. In embodiments, the address generator enables memory subsystem access.

The accessing of the memory subsystem can be based on a variety of techniques, where the techniques can enable more efficient processor operation. In the flow 100, the address generator can enable multi-dimensional tensor access by overlapped striding through the multi-dimensional tensor. Striding can refer to a “distance” in bytes, words, double words, and so in, between adjacent elements. Overlapped striding can be used to obtain data from more than one submatrix, for example. In embodiments, the overlapped striding can enable redundant data elements to be stored in the FIFO. While the redundant data can consume some FIFO storage, providing the redundant data can reduce processing latency for operations such as tensor operations by reducing a number of accesses to data within the memory subsystem. The amount of overlap for the overlapped striding can enable calculations such as matrix calculations. In embodiments, the overlapped striding can enable convolution calculations. Other calculations and functions can be enabled by the overlapped striding. In other embodiments, the overlapped striding can enable matrix multiply functionality. As discussed throughout, the FIFO filling logic can be used to access or load a variety of types of data into the FIFO, based on an address. In embodiments, the FIFO filling logic can use the address generator to enable loading of small submatrices of a tensor stored in the memory subsystem into the FIFO for use by the processor. The submatrices can include N×M submatrices, N×N submatrices, and the like. In embodiments, N=2, and M can equal 2 or 3. In embodiments, the FIFO filling logic provides the FIFO with non-unique elements of the tensor.

The flow 100 includes consuming, by the processor, an element stream from the FIFO 150, where the element stream flows to the FIFO from the memory subsystem through the FIFO filling logic. The element stream can include data such as tensor data. In embodiments, the element stream from the FIFO comprises elements of a tensor. Consuming of the element stream can include performing operations such logical operations, mathematical operations, and so on. In embodiments, the consuming comprises performing tensor calculations. Other types of calculations can be performed, where the calculations can be based on elements of a data flow graph, kernels, agents, nets or networks, and so on. In the flow 100, the processor and memory subsystem implement machine learning 152. The machine learning can be based on a network such as a machine learning network. In embodiments, the machine learning utilizes one or more neural networks. The one or more neural networks can include layers, where the layers can include input layers, output layers, convolutional layers, bottleneck layers, max pooling layers, and so on. In embodiments, the one or more neural networks comprise a convolutional neural network. Other neural network techniques can also be used. In further embodiments, the one or more neural networks can include a recurrent neural network. Other machine learning techniques can be applied. In further embodiments, the processor and memory subsystem implement deep learning 154.

In embodiments, the flow 100 includes consuming, by the processor, multiple element streams supplied by using additional FIFO(s) and FIFO filling logic 160. The additional FIFO(s) and FIFO filling logic can be configured identically to or different from the first FIFO and FIFO filling logic. For example, the first FIFO can have the same or a different depth as the additional FIFO(s), depending on the desired element stream to be processed. In embodiments, the FIFO is used to feed a first data element stream to the processor, wherein the data elements provide input for an arithmetic operation. In embodiments, the arithmetic operation comprises tensor multiplication. Other embodiments further comprise an additional FIFO configured to feed a second data element stream to the processor. The additional FIFO can be supplied by additional FIFO filling logic. In some embodiments, a common address generator supplies addresses to the FIFO filling logic and the additional FIFO filling logic. In other embodiments, unique address generators are used for each FIFO filling logic.

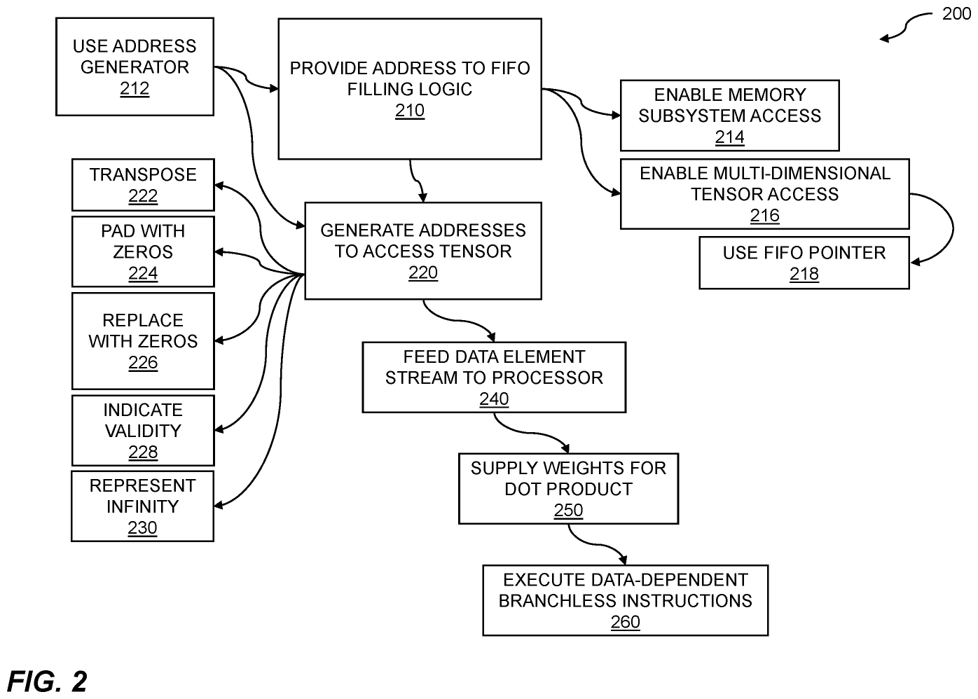

FIG. 2 is a flow diagram for data-dependent branchless instructions. As discussed throughout, a FIFO can be configured to provide data to a processor for performing calculations such as tensor calculations. The FIFO can be filled with data, at times including redundant data or non-unique data, to reduce the number of memory accesses required to obtain data from a memory subsystem. The memory subsystem can include fast memory and slow memory. Data-dependent branchless instructions can be used to replace branch instructions within a program, code, function, routine, subroutine, and so on. Branch instructions can be problematic to processors, such as parallel processors, since a sequence of instructions fetched based on a presumed branch outcome may not be the correct sequence of instructions. If the incorrect sequence of instructions is fetched, then the erroneous instructions must be flushed, and the correct sequence of instructions fetched. The processor can be idle while the correct sequence of instructions is being fetched. Data-dependent branchless instructions can be used to support parallel processing or other processing by the processor. Data-dependent branchless instructions can support FIFO filling logic for tensor calculation.

The flow 200 includes providing an address to the FIFO filling logic 210 for accessing data from the memory subsystem. The memory subsystem can include memories of various sizes, speeds, and so on. In embodiments, the memory subsystem can include a slower access memory and a faster access memory. The address can enable access to the slow memory or the fast memory, where the slow memory or the fast memory of the memory subsystem can be within the memory subsystem or coupled to the memory subsystem. The access speeds of the slow memory and the fast memory can be significantly different speeds, where the memory speeds can impact processor latency. In embodiments, the faster access memory, when accessed, can reduce processor latency by at least an order of magnitude over accessing the slower access memory. The slow memory and the fast memory can be of different sizes. In embodiments, the faster access memory is at least an order of magnitude smaller than the slower access memory. The slow memory or the fast memory can include various memory types. In embodiments, the memory subsystem can include direct memory access (DMA) memory. The DMA memory can include remote DMA (RDMA) memory where the DMA memory can be located remotely from the memory subsystem. In other embodiments, the memory subsystem can include high performance memory (HPM). HPM can include high bandwidth memory (HBM™) or other fast memory. The address can include an address for accessing the fast memory or the slow memory. The address is provided using an address generator 212. The address generator can include software or hardware for generating the address. The address generator can enable memory subsystem access 214. The access can be enabled by configuring communication channels or switching channels to the memory subsystem. In embodiments, the address generator includes a second processor. The processor and the second processor can be colocated within reconfigurable hardware such as a reconfigurable fabric. In the flow 200, the address generator enables multi-dimensional tensor access 216 by overlapped striding through the multi-dimensional tensor. The overlapped striding can provide non-unique elements of the tensor, multi-dimensional tensor, etc. The multi-dimensional tensor access can be accomplished using various techniques. In the flow 200, the address generator enables multi-dimensional tensor access using a FIFO pointer 218.

The flow 200 further includes generating addresses 220, using the address generator 212, to access a tensor stored in the memory subsystem based on a small N×M submatrix from within the tensor. A matrix such as a matrix that represents a tensor can be partitioned into submatrices. The submatrices can include submatrices of different sizes and shapes. The shapes can include square matrices, rectangular matrices, etc. The submatrices can include overlapping matrices, where the overlapping matrices can be accessed based on the overlapped striding. The submatrices can be large or small. In embodiments, the small N×M submatrix can include N=2 and M=3. The values of N or M can be larger or smaller. In other embodiments, the small N×M submatrix can include N=2 and M=2. Various operations can be performed on the data within the submatrices either by fetching the data, processing the data, etc. In embodiments, elements of the small N×M submatrix are transposed 222. A transposed matrix or submatrix can be generated by flipping the matrix or submatrix about a diagonal. The columns of the N×M matrix are swapped with the rows of the N×M matrix. The result of transposing an N×M matrix is an M×N matrix. In other embodiments, elements of the small N×M submatrix are padded with zeros 224. A matrix or submatrix can be padded with zeros to compensate for missing data, to pad matrices to make them the same sizes, etc. In further embodiments, the elements of the small N×M submatrix are replaced with zeros 226 to indicate validity 228. Various techniques can be used to indicate non-numerical values (e.g. not a number), special numbers, and so on. The zero values within the small submatrix can indicate that the submatrix is valid, the matrix is valid, etc. In embodiments, the elements of the small N×M submatrix are replaced with mathematical representations of infinity 230 to indicate validity. The mathematical representations can indicate positive infinity, negative infinity, or other special numerical values.

In the flow 200, the FIFO is used to feed a data element stream to the processor 240. In embodiments, the data elements provide input for a dot product operation. A dot product or scalar product operation can be performed on the data provided by the FIFO to the processor. The processor can perform a variety of matrix operations such as the dot product. The flow 200 further includes supplying weights for the dot product 250 operation through an input path to the processor, different from an input supplied by the FIFO. As discussed throughout, data can be accessed within the memory subsystem, and provided to the processor via the FIFO. In some configurations of the processor, techniques other than using the FIFO can be available for providing data to the processor. The other techniques can include memory access techniques such as DMA access, RDMA access, and so on. The other techniques can further include data paths, communications channels, and the like. In the flow 200, the processor executes data-dependent branchless instructions 260. Data-dependent branchless instructions can be used to replace conditional instructions, such as branch instructions, with a sequence of instructions which can be executed irrespective of whether a branch is taken. The sequence of instructions used to replace the branch instruction can be executed by the processor without risking a wrong or invalid branch outcome. The data-dependent branchless instructions can be dependent on the processor architecture. The data-dependent branchless instructions can be based on logical identities, numbering representations such as two's complement numbering representations, and so on. A variety of operations can be performed based on the data-dependent branchless instructions. In embodiments, the operations can be related to machine learning. The operations can be related to operations within a network such as a neural network. The neural network can include a convolutional neural network, a recurrent neural network, etc. In embodiments, the data-dependent branchless instructions can implement at least part of a tensor convolution function. Other operations related to matrix manipulation, neural network processing, and so on, can be performed. In further embodiments, the data-dependent branchless instructions can implement at least part of a tensor max pooling function.

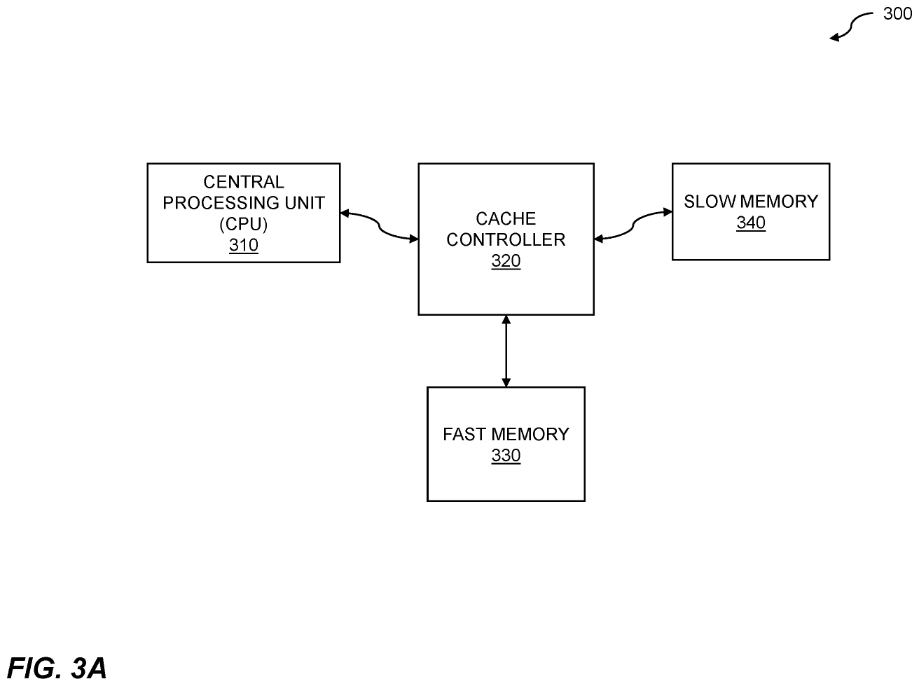

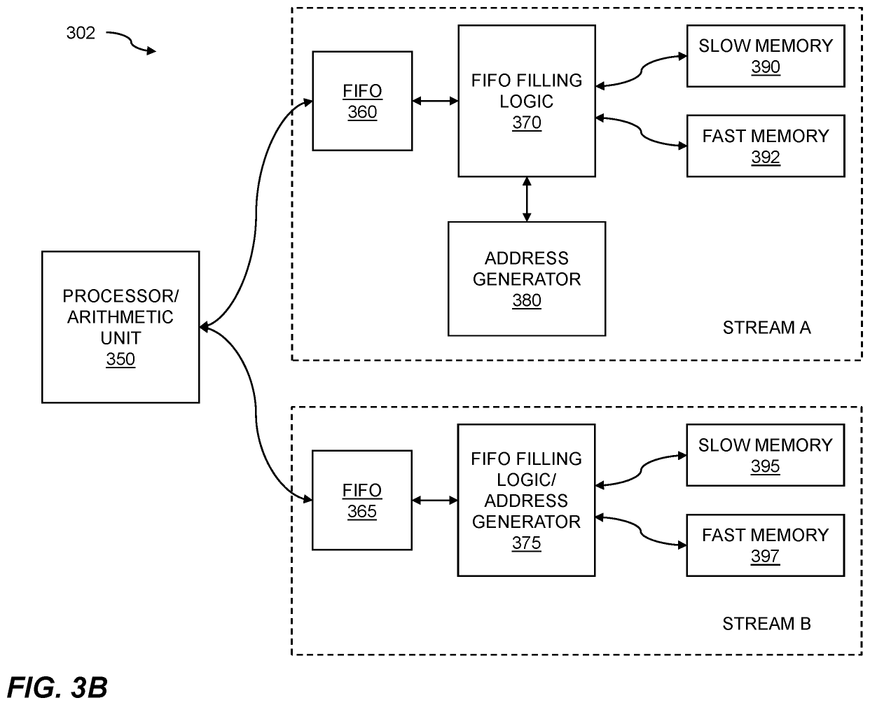

FIG. 3A shows a processor and memory subsystem with cache control. Data can be accessed by a processor from a memory subsystem, where the memory subsystem can include fast memory or slow memory. The processor can include allocated clusters of elements within a reconfigurable fabric. Since accessing memory external to the processor can be significantly slower than accessing memory local to the processor, a cache control component can be inserted between the processor and the memory subsystem. A cache control component can include hardware or software. The hardware or software can store data, instructions, etc., in a small, fast memory adjacent to the processor. When the processor requests an instruction such as the next instruction in a sequence of instructions, or a next data element, the processor can first check whether the instruction or the data is contained within the cache. Instructions or data can be stored within the cache as a result of a previous instruction fetch, a data request, and so on. If the instruction or data is found within the cache, the fetch or request is said to “hit” contents of the cache. If the instruction or data is not found within the cache, then the instruction fetch or data request is sent to external memory, either fast external memory or slow external memory. A processor and memory subsystem with cache control can be used for tensor calculation.

A processor and memory subsystem with cache control is shown 300. The subsystem can include a central processing unit (CPU) 310. The CPU can include clusters of elements within a reconfigurable fabric, where the elements can include processing elements, storage elements, or switching elements. The processor can be in communication with a cache controller 320. The cache controller can include clusters of elements within the reconfigurable fabric, can be external to the reconfigurable fabric, etc. The cache controller can include storage for instructions or data. The instructions can include instructions from a sequence of instructions that can be executed by the processor. The data can include data elements within an array or matrix, data structures such as tensors or multi-dimensional tensors, and the like. The cache storage can be small so that access to the cache storage can be fast when a cache hit occurs. When the instruction or the data is not found within the cache, a cache “miss” occurs. If a cache miss occurs, then the request for an instruction or for data is passed along to external memory. The external memory can include a fast memory 330. The fast memory may contain the next instruction, the data, etc. The external memory can include a slow memory 340. The slow memory can be larger than the fast memory. The slow memory can be significantly slower than the cache or the fast memory. Access to the slow memory can be computationally expensive in that the longest delay can be incurred while obtaining instructions or data for the processor.

FIG. 3B shows a data access using FIFO filling logic 302. FIFO filling logic can enable tensor calculation. A processor and a memory subsystem for data manipulation are obtained. A FIFO is configured between the processor and the memory subsystem, and FIFO filling logic is configured between the FIFO and the memory subsystem. The processor consumes an element stream from the FIFO, where the element stream flows to the FIFO from the memory subsystem through the FIFO filling logic. The FIFO filling logic can provide the element stream to the FIFO based on overlapped striding, where overlapped striding enables redundant data elements to be stored in the FIFO. The redundant data elements can be stored in the FIFO in order to reduce data access delays that can be incurred when accessing external memory such as a fast memory or a slow memory.

Data access using FIFO filling logic includes a processor or arithmetic processing unit 350. The processor can be based on clusters of elements within a reconfigurable fabric, on reconfigurable hardware such as programmable chips, on reconfigurable processors, and so on. The processor can access data or instructions from a FIFO 360. The FIFO can be loaded data such as arrays, matrices, submatrices, tensors, multi-dimensional tensors, etc. The FIFO can be loaded using FIFO filling logic 370. The FIFO filling logic can provide data to the FIFO based on an address. Embodiments include providing an address to the FIFO filling logic for accessing data from the memory subsystem using an address generator 380. The address generator can include software or hardware. The address generator can be implemented within the processor. In embodiments, the address generator comprises a second processor. The address generated by the address generator can enable memory subsystem access. The memory subsystem can include slow memory 390 or fast memory 392. In embodiments, the memory subsystem can include direct memory access (DMA) memory. The DMA memory can include remote DMA memory. In other embodiments, the memory subsystem can include high performance memory (HPM). The HPM can be shared by more than one processor, memory subsystem, etc. In embodiments, the address generator can enable multi-dimensional tensor access by overlapped striding through the multi-dimensional tensor. The overlapped striding can include accessing redundant data. An amount of redundant data can be accessed. The amount of redundant data that can be accessed can be determined based on a tradeoff of computational resources. The computational resources can include the cost of FIFO storage or storage within the processor balanced against the delay associated with accessing data within external fast memory or slow memory.

FIFO filling logic 302 can supply multiple element streams to processor 350 through a configuration of multiple FIFOs and FIFO filling logic structures. For example, FIFO 360, FIFO filling logic 370, address generator 380, slow memory 390, and fast memory 392 can provide element stream A to processor 350. Stream A can comprise data elements, such as vectors or tensors, to be used as operands in an arithmetic operation, such as a multiplication operation, in processor 350. A second element stream can be configured to provide a second stream of data elements, such as vectors or tensors, to also be used as operands in an arithmetic operation, along with the data elements of stream A. For example, FIFO 365, FIFO filling logic and address generator 375, slow memory 395, and fast memory 397 can provide element stream B to processor 350. The sequencing, overlapped striding, data duplication, etc. provided by the two FIFOs and FIFO filling logic streams can be the same or different, depending on the needs of the operation and the types of data elements involved as operands. For example, stream A can provide a tensor multiplicand that is provided and stridden along a row-based access, while stream B can provide a tensor multiplier provided along a column-based access. In embodiments, the tensor multiplier can be a weight tensor for neural network processing. In embodiments, address generator 380 can supply addressing to FIFO filling logic 370 and FIFO filling logic 375 because stream A and stream B can be synchronized. Slow memory 390 and 395 can be the same memory, depending on the needs of the operation. Fast memory 392 and fast memory 397 can be the same memory, depending on the needs of the operation. More than two streams can be configured to supply the processor 350.

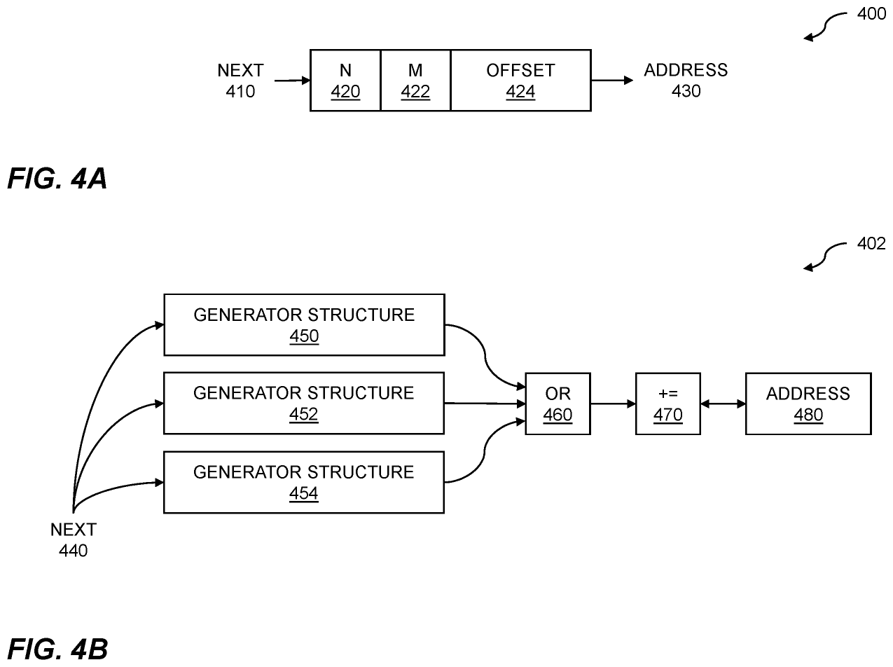

FIG. 4A illustrates address generation structure. An address can be generated using an address generator. An address generated by the address generator can be used to provide an address to FIFO filling logic, where the FIFO filling logic can use the address to access data from a memory subsystem. The memory subsystem can include slow memory, fast memory, DMA memory, high performance memory, and the like. The address generator can include a software address generator such as a program or code, a routine, a function, and so on. In embodiments, the address generator can include a second processor. The address generator can be used to access a variety of data types, data structure types, and so on. In embodiments, the address generator can enable multi-dimensional tensor access by overlapped striding through the multi-dimensional tensor. The address generation structure supports FIFO filling for tensor calculation.

An address generation structure 400 is shown. The address generation structure can generate an address to be provided to the FIFO filling logic, where the FIFO filling logic can access data from the memory subsystem. The provided address can enable access to a matrix, a tensor, a multi-dimensional tensor, or other data or data structure. The provided address can enable access to a submatrix within a matrix. In embodiments, the address generator can enable multi-dimensional tensor access by overlapped striding through the multi-dimensional tensor. The overlapped striding can enable access to data that spans more than one submatrix. The address generation structure comprises one or more fields. The example address generation structure includes an input for generating the next address 410, a count field N 420, an offset count field M 422, a field offset 424, and a generated address 430. For the address generation structure shown, the address generation technique includes doing nothing for N−1 times that the next input is encountered. On the Nth time, an offset is output as an address. After M−1 offsets have been output, when the next signal is subsequently encountered, no action is taken.

FIG. 4B illustrates address generation logic 402. Logic can be used to generate an address for accessing data from a memory subsystem. The memory subsystem can include fast memory or slow memory. Address generation logic can enable FIFO filling logic for tensor calculation. A processor and a memory subsystem for data manipulation are obtained. A FIFO is configured between the processor and the memory subsystem, where the FIFO is coupled with the processor. FIFO filling logic is configured between the FIFO and the memory subsystem, where the FIFO filling logic is connected to the FIFO and the memory subsystem. The processor consumes an element stream from the FIFO, where the element stream flows to the FIFO from the memory subsystem through the FIFO filling logic. In embodiments, the FIFO filling logic can provide the FIFO with non-unique elements of the tensor. The non-unique elements can result from overlapping striding which has been enabled by an address generator.

An input signal Next 440 can be coupled to one or more generator structures such as a first generator structure 450, a second generator structure 452, a third generator structure 454, and so on. While three generator structures are shown, other numbers of generator structures may be used. The generator structures can be combined using a logical OR 460 operation. The generator structures may not each generate offsets during a given next input cycle, so the offsets would not conflict. The results of the OR logical operation can be incremented using+=logic 470. The results of the incrementing can be output as a generated address 480.

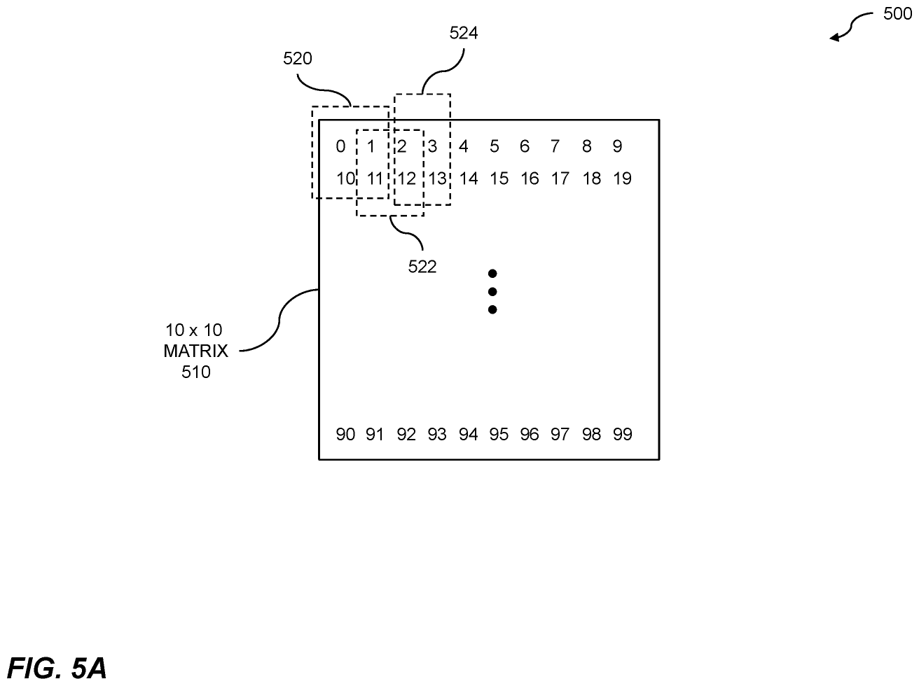

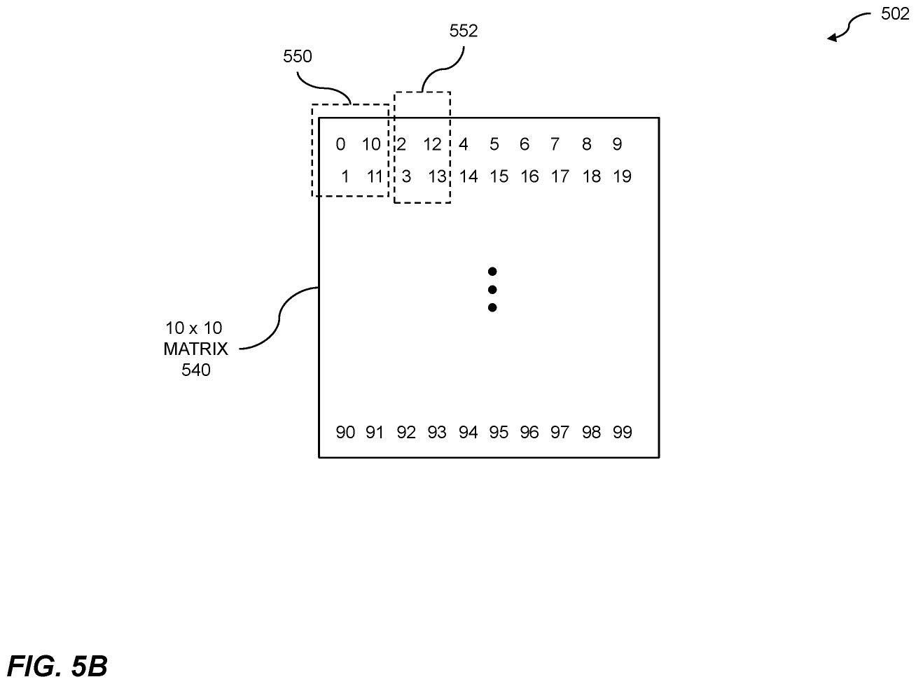

FIG. 5A shows data matrices with overlapped striding 500. Data, such as matrix data, tensor data, multidimensional tensor data, and so on, can be stored in one or more data structures such as one or more arrays. An array can represent a convenient organization of the data for operations such as matrix operations. The matrix operations can include addition or subtraction, transposition, scalar or matrix multiplication, and so on. Within the context of the matrix, a stride can include a distance from one element of the matrix or array to a next element of the matrix or array. The stride can refer to a number of bytes, words, double words, etc. of storage that can be traversed to reach a beginning of a next element. The stride can further refer to groups of elements within the matrix or array such as a submatrix. An overlapping stride can be used to enable an “overlap” of elements such as submatrices. The overlapping can support a variety of array operations, matrix operations, tensor operations, and the like. To support the overlapping, redundant data from an array, a subarray, a matrix, a submatrix, etc., can be loaded into a FIFO for processing by a processor. The overlapped stride 500 can support FIFO filling logic for tensor operation.

An example matrix 510 is shown. While a 10×10 matrix is shown, the matrix can include a matrix of other dimensions. The matrix can be a square matrix, a rectangular matrix, and so on. The 10×10=100 elements of the matrix are numbered element 0 to element 99. The elements can be organized into submatrices, such as a first submatrix 520, a second submatrix 522, a third submatrix 524, and so on. The number of submatrices into which the matrix data is organized can be chosen based on operations that can be performed on the data. An address generator can be used to determine a stride, an overlapping stride, etc. The stride such as an overlapping stride can be used for loading data such as tensor data for processing. In embodiments, the FIFO filling logic can use the address generator to enable loading of small submatrices of a tensor stored in the memory subsystem into the FIFO for use by the processor. The data loaded from the small submatrices can include unique data when striding is used, redundant data when overlapped striding is used, and so on. In embodiments, the FIFO filling logic can provide the FIFO with non-unique elements of the tensor. The small submatrices can be loaded from matrices of various dimensions. In embodiments, the address generator can enable multi-dimensional tensor access using a FIFO pointer.

The submatrices can include dimensions N×N, N×M, and so on. Embodiments include generating addresses, using the address generator, to access a tensor stored in the memory subsystem based on a small N×M submatrix from within the tensor. The submatrices that can be loaded by the FIFO filling logic into the FIFO can be based on various dimensions. Further embodiments include generating addresses, using the address generator, to access a tensor stored in the memory subsystem based on a small N×M submatrix from within the tensor. The sizes of the small matrices can enable computationally efficient operations by the processor. The submatrix can include a rectangular submatrix. In embodiments, the small N×M submatrix can include N=2 and M=3. The submatrix can include a square matrix. In embodiments, the small N×M submatrix includes N=2 and M=2. Note that submatrix 422 overlaps submatrices 420 and 424. The overlap of the submatrices can represent non-unique data that can be provided by the FIFO filling logic to the FIFO.

FIG. 5B shows transposed data matrices with striding 502. A matrix, such as an N×M matrix can include data, where the data can include tensor data, multidimensional tensor data, and so on. The matrix can be partitioned into submatrices, where the submatrices can be used to reduce computational complexity of various matrix operations such as matrix addition, subtraction, multiplication, and so on. Among the matrix operations, the matrix, submatrices, etc., can be transposed. Transposing the matrix can include “flipping” or rotating the matrix or submatrix about a diagonal through the matrix or submatrix. The transposed matrix or submatrix can be used for matrix computations such as computing a dot product between two matrices. Transposed data matrices can be used for FIFO filling logic for tensor calculation. A processor and a memory subsystem for data manipulation are obtained. A FIFO is configured between the processor and the memory subsystem, where the FIFO is coupled with the processor. FIFO filling logic is configured between the FIFO and the memory subsystem, where the FIFO filling logic is connected to the FIFO and the memory subsystem. The processor consumes an element stream from the FIFO, where the element stream flows to the FIFO from the memory subsystem through the FIFO filling logic.

An example 10×10 matrix 540 is shown. While a square matrix is shown, the matrix can include a matrix of other dimensions and shapes. The matrix can be a square matrix as shown, a rectangular matrix, and so on. The 10×10=100 elements of the matrix are numbered element 0 to element 99. The elements of the matrix can be organized into submatrices, such as a first submatrix 550, a second submatrix 552, and so on. The submatrices can include transposed matrices. In the example, submatrix 550 can be a transpose of submatrix 520; submatrix 552 can be a transpose of submatrix 524, and so on. Striding can be used to access data from the one or more matrices or submatrices, where the matrices or submatrices can be loaded into the memory subsystem. Embodiments include providing an address to the FIFO filling logic for accessing data from the memory subsystem using an address generator. The address that is generated can enable access to various types of data structures such as a matrix, a tensor, and so on. In embodiments, the address generator can enable multi-dimensional tensor access by overlapped striding through the multi-dimensional tensor.

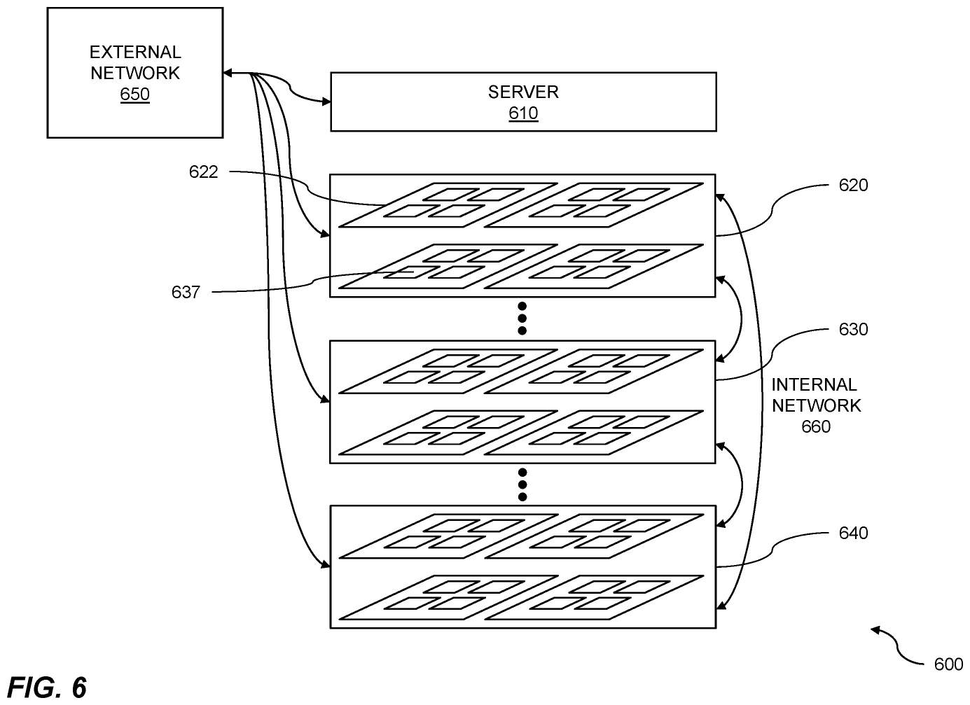

FIG. 6 shows a server allocating FIFOs and processing elements. A data flow graph, directed flow graph, Petri Net, network, and so on, can be allocated to first in first out registers (FIFO) and to elements. The elements can include processing elements, storage elements, switching elements, and so on. First in first out (FIFO) techniques can be used to support FIFO filling logic for tensor calculation. The FIFOs and the processing elements can be elements within a reconfigurable fabric. The processing elements can be grouped into clusters, where the clusters can be configured to execute one or more functions. The processing elements can be configured to implement kernels, agents, a data flow graph, a network, and so on, by programming, coding, or “scheduling” rotating circular buffers. The circular buffers can be statically scheduled. A processor and a memory subsystem for data manipulation are obtained. A FIFO is configured between the processor and the memory subsystem, and FIFO filling logic is configured between the FIFO and the memory subsystem. The processor consumes an element stream from the FIFO.

The system 600 can allocate one or more first in first outs (FIFOs) and processing elements (PEs) for reconfigurable fabric data routing. The system can include a server 610 allocating FIFOs and processing elements. In embodiments, system 600 includes one or more boxes, indicated by callouts 620, 630, and 640. Each box may have one or more boards, indicated generally as 622. Each board comprises one or more chips, indicated generally as 637. Each chip may include one or more processing elements, where at least some of the processing elements may execute a process agent, a kernel, or the like. An internal network 660 allows for communication between and among the boxes such that processing elements on one box can provide and/or receive results from processing elements on another box.

The server 610 may be a computer executing programs on one or more processors based on instructions contained in a non-transitory computer readable medium. The server 610 may perform reconfiguring of a mesh-networked computer system comprising a plurality of processing elements with a FIFO between one or more pairs of processing elements. In some embodiments, each pair of processing elements has a dedicated FIFO configured to pass data between the processing elements of the pair. The server 610 may receive instructions and/or input data from external network 650. The external network may provide information that includes, but is not limited to, hardware description language instructions (e.g. Verilog, VHDL, or the like), flow graphs, source code, or information in another suitable format.

The server 610 may collect performance statistics on the operation of the collection of processing elements. The performance statistics can include the number of fork or join operations, average sleep time of a processing element, and/or a histogram of the sleep time of each processing element. Any outlier processing elements that sleep for a time period longer than a predetermined threshold can be identified. In embodiments, the server can resize FIFOs or create new FIFOs to reduce the sleep time of a processing element that exceeds the predetermined threshold. Sleep time is essentially time when a processing element is not producing meaningful results, so it is generally desirable to minimize the amount of time a processing element spends in a sleep mode. In some embodiments, the server 610 may serve as an allocation manager to process requests for adding or freeing FIFOs, and/or changing the size of existing FIFOs in order to optimize operation of the processing elements.

In some embodiments, the server may receive optimization settings from the external network 650. The optimization settings may include a setting to optimize for speed, optimize for memory usage, or balance between speed and memory usage. Additionally, optimization settings may include constraints on the topology, such as a maximum number of paths that may enter or exit a processing element, maximum data block size, and other settings. Thus, the server 610 can perform a reconfiguration based on user-specified parameters via the external network 650.

Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include calculation input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PEs). The processing elements can include a processor, a data memory, an instruction memory, communications capabilities, and so on. Multiple PEs can be grouped, where the groups can include pairs, quads, octets, etc. The PEs positioned in arrangements such as quads can be coupled to arithmetic units, where the arithmetic units can be coupled to or included in data processing units (DPUs). The DPUs can be shared between and among quads. The DPUs can provide arithmetic techniques to the PEs, communications between quads, and so on.

The data flow processors, including data flow processors arranged in quads, can be loaded with kernels. The kernels can be a portion of a data flow graph. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0, then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. A configuration mode can be entered. Various techniques, including direct memory access (DMA) can be used to load instructions from the kernel into instruction memories of the PEs. The clusters that were preprogrammed to enter configuration mode can be preprogrammed to exit configuration mode. When configuration mode has been exited, execution of the one or more kernels loaded onto the clusters can commence. In embodiments, clusters can be reprogrammed and during the reprogramming, switch instructions used for routing are not disrupted so that routing continues through a cluster.

Data flow processes that can be executed by data flow processor can be managed by a software stack. A software stack can include a set of subsystems, including software subsystems, which may be needed to create a software platform. A complete software platform can include a set of software subsystems required to support one or more applications. A software stack can include both offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™ CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so one. The agent source code that can be operated on by the software development kit can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit can include a variety of tools which can be used to support a deep learning technique or other technique which requires processing of large amounts of data such as unstructured data. The SDK can support multiple machine learning techniques such as machine learning techniques based on GEMM™, sigmoid, and so on. The SDK can include a low-level virtual machine (LLVM) which can serve as a front end to the SDK. The SDK can include a simulator. The SDK can include a Boolean satisfiability solver (SAT solver). The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a flow graph.

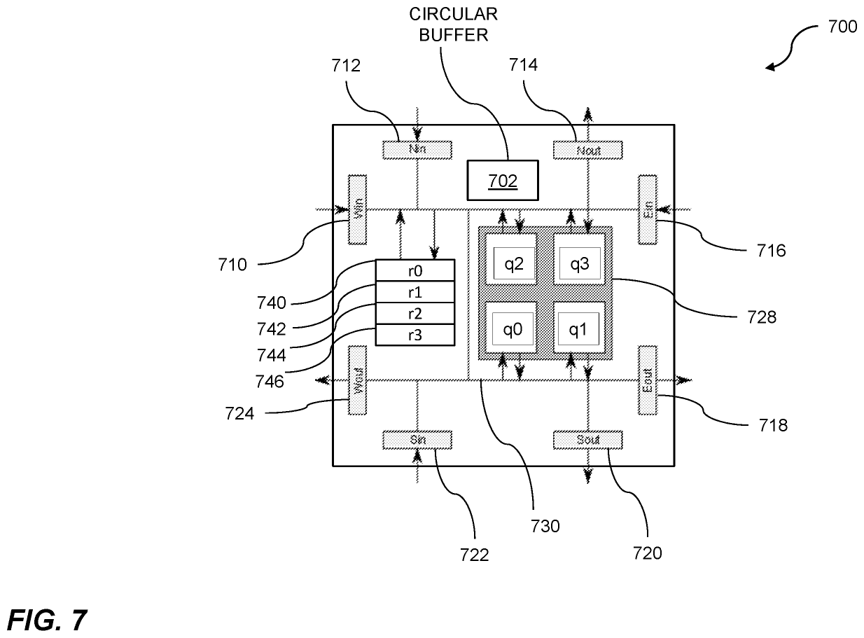

FIG. 7 shows a cluster for coarse-grained reconfigurable processing. The cluster 700 for coarse-grained reconfigurable processing can be used for FIFO filling logic for tensor calculation. The FIFO filling logic can be implemented within reconfigurable hardware such as a reconfigurable fabric. The configuration of the reconfigurable fabric includes allocating a plurality of clusters within a reconfigurable fabric, where the plurality of clusters is configured to execute one or more functions. The functions can include tensor calculations. The clusters can include processing elements, switching elements, storage elements, and so on. A processor and a memory subsystem for data manipulation are obtained. A FIFO is configured between the processor and the memory subsystem, where the FIFO is coupled with the processor, and FIFO filling logic is configured between the FIFO and the memory subsystem, where the FIFO filling logic is connected to the FIFO and the memory subsystem. The processor consumes an element stream from the FIFO, wherein the element stream flows to the FIFO from the memory subsystem through the FIFO filling logic.

The cluster 700 comprises a circular buffer 702. The circular buffer 702 can be referred to as a main circular buffer or a switch-instruction circular buffer. In some embodiments, the cluster 700 comprises additional circular buffers corresponding to processing elements within the cluster. The additional circular buffers can be referred to as processor instruction circular buffers. The example cluster 700 comprises a plurality of logical elements, configurable connections between the logical elements, and a circular buffer 702 controlling the configurable connections. The logical elements can further comprise one or more of switching elements, processing elements, or storage elements. The example cluster 700 also comprises four processing elements—q0, q1, q2, and q3. The four processing elements can collectively be referred to as a “quad,” and can be jointly indicated by a grey reference box 728. In embodiments, there is intercommunication among and between each of the four processing elements. In embodiments, the circular buffer 702 controls the passing of data to the quad of processing elements 728 through switching elements. In embodiments, the four processing elements 728 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 700 can further comprise storage elements coupled to the configurable connections. As shown, the cluster 700 comprises four storage elements—r0 740, r1 742, r2 744, and r3 746. The cluster 700 further comprises a north input (Nin) 712, a north output (Nout) 714, an east input (Ein) 716, an east output (Eout) 718, a south input (Sin) 722, a south output (Sout) 720, a west input (Win) 710, and a west output (Wout) 724. The circular buffer 702 can contain switch instructions that implement configurable connections. For example, an instruction effectively connects the west input 710 with the north output 714 and the east output 718 and this routing is accomplished via bus 730. The cluster 700 can further comprise a plurality of circular buffers residing on a semiconductor chip where the plurality of circular buffers controls unique, configurable connections between and among the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 702. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 724 to an instruction placing data on the south output 720, such that the data can be output on both output ports within the same pipeline cycle. In a case where data needs to travel to a cluster that is both south and west of the cluster 700, it can be more efficient to send the data directly to the south output port rather than to store the data in a register first, and then to send the data to the west output on a subsequent pipeline cycle.

An L2 switch interacts with the instruction set. A switch instruction typically has both a source and a destination. Data is accepted from the source and sent to the destination. There are several sources (e.g. any of the quads within a cluster, any of the L2 directions—North, East, South, West, a switch register, or one of the quad RAMs—data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in excessive instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can perform any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A”, to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAMs in different clusters can travel through the same DMA path, but the transactions must be separately defined. A maximum block size for a single DMA transfer can be 8 KB. Accesses to data RAMs can be performed either when the processors are running or while the processors are in a low power “sleep” state. Accesses to the instruction RAMs and the PE and Co-Processor Registers may be performed during configuration mode. The quad RAMs may have a single read/write port with a single address decoder, thus allowing shared access by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

In embodiments, the computations that can be performed on a cluster for coarse-grained reconfigurable processing can be represented by a data flow graph. Data flow processors, data flow processor elements, and the like, are particularly well suited to processing the various nodes of data flow graphs. The data flow graphs can represent communications between and among agents, matrix computations, tensor manipulations, Boolean functions, and so on. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of high quality data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PEs). The processing elements can include a processor, a data memory, an instruction memory, communications capabilities, and so on. Multiple PEs can be grouped, where the groups can include pairs, quads, octets, etc. The PEs arranged in configurations such as quads can be coupled to arithmetic units, where the arithmetic units can be coupled to or included in data processing units (DPUs). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value of minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0, then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the clusters enter the configuration mode, various techniques, including direct memory access (DMA) can be used to load instructions from the kernel into instruction memories of the PEs. The clusters that were preprogrammed configuration mode can also be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as those based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. The data operated on by the agents that are resident within the reconfigurable buffer can include tensors. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

Agents can be used to support dynamic reconfiguration of the reconfigurable fabric. The agents that support dynamic reconfiguration of the reconfigurable fabric can include interface signals in a control unit. The interface signals can include suspend, agent inputs empty, agent outputs empty, and so on. The suspend signal can be implemented using a variety of techniques such as a semaphore, a streaming input control signal, and the like. When a semaphore is used, the agent that is controlled by the semaphore can monitor the semaphore. In embodiments, a direct memory access (DMA) controller can wake the agent when the setting of the semaphore has been completed. The streaming control signal, if used, can wake a control unit if the control unit is sleeping. A response received from the agent can be configured to interrupt the host software.

The suspend semaphore can be asserted by runtime software in advance of commencing dynamic reconfiguration of the reconfigurable fabric. Upon detection of the semaphore, the agent can begin preparing for entry into a partially resident state. A partially resident state for the agent can include having the agent control unit resident after the agent kernel is removed. The agent can complete processing of any currently active tensor being operated on by the agent. In embodiments, a done signal and a fire signal may be sent to upstream or downstream agents, respectively. A done signal can be sent to the upstream agent to indicate that all data has been removed from its output buffer. A fire signal can be sent to a downstream agent to indicate that data in the output buffer is ready for processing by the downstream agent. The agent can continue to process incoming done signals and fire signals, but will not commence processing of any new tensor data after completion of the current tensor processing by the agent. The semaphore can be reset by the agent to indicate to a host that the agent is ready to be placed into partial residency. In embodiments, having the agent control unit resident after the agent kernel is removed comprises having the agent partially resident. A control unit may not assert one or more signals, nor expect one or more responses from a kernel in the agent, when a semaphore has been reset.

Other signals from an agent can be received by a host. The signals can include an agent inputs empty signal, an agent outputs empty signal, and so on. The agent inputs empty signal can be sent from the agent to the host and can indicate that the input buffers are empty. The agent inputs empty signal can only be sent from the agent when the agent is partially resident. The agent outputs empty signal can be sent from the agent to the host and can indicate that the output buffers are empty. The agent outputs empty signal can only be sent from the agent to the host when the agent is partially resident. When the runtime (host) software receives both signals, agent inputs empty and agent outputs empty, from the partially resident agent, the agent can be swapped out of the reconfigurable fabric and can become fully vacant.

Recall that an agent can be one of a plurality of agents that form a data flow graph. The data flow graph can be based on a plurality of subgraphs. The data flow graph can be based on agents which can support three states of residency: fully resident, partially resident, and fully vacant. A complete subsection (or subgraph) based on the agents that support the three states of residency can be swapped out of the reconfigurable fabric. The swapping out of the subsection can be based on asserting a suspend signal input to an upstream agent. The asserting of the suspend signal can be determined by the runtime software. When a suspend signal is asserted, the agent can stop consuming input data such as an input sensor. The tensor can queue within the input buffers of the agent. The agent kernel can be swapped out of the reconfigurable fabric, leaving the agent partially resident while the agent waits for the downstream agents to drain the output buffers for the agent. When an upstream agent is fully resident, the agent may not be able to be fully vacant because a fire signal might be sent to the agent by the upstream agent. When the upstream agent is partially resident or is fully vacant, then the agent can be fully vacated from the reconfigurable fabric. The agent can be fully vacated if it asserts both the input buffers empty and output buffers empty signals.

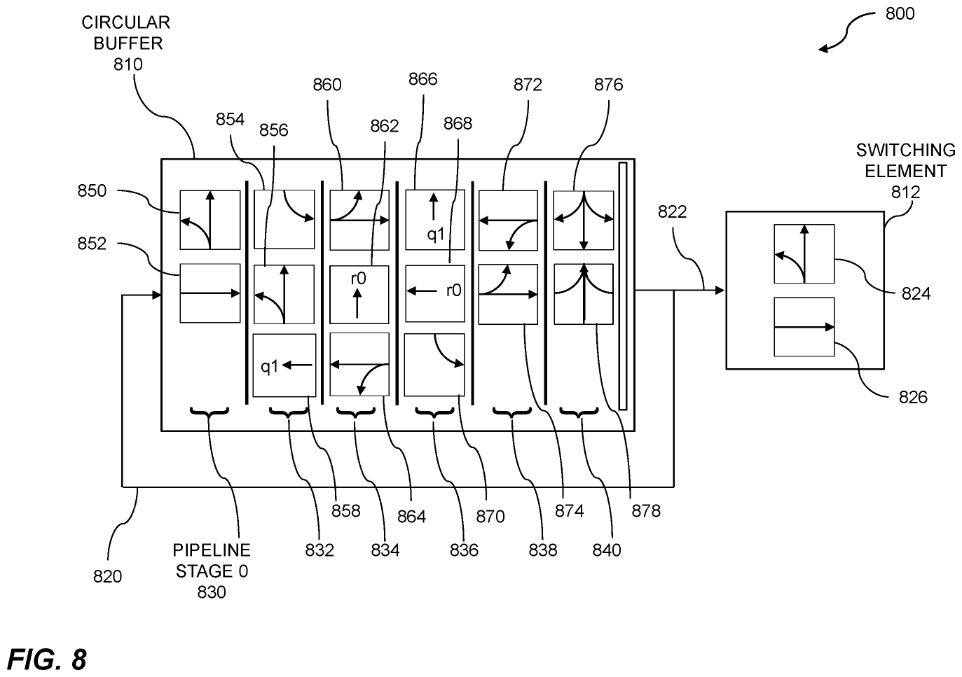

FIG. 8 illustrates a block diagram 800 of a circular buffer. The circular buffer can include a switching element 812 corresponding to the circular buffer. The circular buffer and the corresponding switching element can be used in part for FIFO filling logic for tensor calculation. Using the circular buffer 810 and the corresponding switching element 812, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 800 describes a processor-implemented method for data manipulation. The circular buffer 810 contains a plurality of pipeline stages. Each pipeline stage contains one or more instructions, up to a maximum instruction depth. In the embodiment shown in FIG. 8, the circular buffer 810 is a 6×3 circular buffer, meaning that it implements a six-stage pipeline with an instruction depth of up to three instructions per stage (column). Hence, the circular buffer 810 can include one, two, or three switch instruction entries per column. In some embodiments, the plurality of switch instructions per cycle can comprise two or three switch instructions per cycle. However, in certain embodiments, the circular buffer 810 supports only a single switch instruction in a given cycle. In the example 800 shown, Pipeline Stage 0 830 has an instruction depth of two instructions 850 and 852. Though the remaining pipeline stages 1-5 are not textually labeled in the FIG. 800, the stages are indicated by callouts 832, 834, 836, 838, and 840. Pipeline stage 1 832 has an instruction depth of three instructions 854, 856, and 858. Pipeline stage 2 834 has an instruction depth of three instructions 860, 862, and 864. Pipeline stage 3 836 also has an instruction depth of three instructions 866, 868, and 870. Pipeline stage 4 838 has an instruction depth of two instructions 872 and 874. Pipeline stage 5 840 has an instruction depth of two instructions 876 and 878. In embodiments, the circular buffer 810 includes 64 columns. During operation, the circular buffer 810 rotates through configuration instructions. The circular buffer 810 can dynamically change operation of the logical elements based on the rotation of the circular buffer. The circular buffer 810 can comprise a plurality of switch instructions per cycle for the configurable connections.

The instruction 852 is an example of a switch instruction. In embodiments, each cluster has four inputs and four outputs, each designated within the cluster's nomenclature as “north,” “east,” “south,” and “west” respectively. For example, the instruction 852 in the diagram 800 is a west-to-east transfer instruction. The instruction 852 directs the cluster to take data on its west input and send out the data on its east output. In another example of data routing, the instruction 850 is a fan-out instruction. The instruction 850 instructs the cluster to take data from its south input and send out on the data through both its north output and its west output. The arrows within each instruction box indicate the source and destination of the data. The instruction 878 is an example of a fan-in instruction. The instruction 878 takes data from the west, south, and east inputs and sends out the data on the north output. Therefore, the configurable connections can be considered to be time multiplexed.

In embodiments, the clusters implement multiple storage elements in the form of registers. In the example 800 shown, the instruction 862 is a local storage instruction. The instruction 862 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is complete. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep and awaits the arrival of valid data. Upon arrival of the valid data, the cluster is woken and the data stored. Accesses to one or more data random access memories (RAMs) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 858 is a processing instruction. The instruction 858 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 800 shown, the circular buffer 810 rotates instructions in each pipeline stage into switching element 812 via a forward data path 822, and also back to a pipeline stage 0 830 via a feedback data path 820. Instructions can include switching instructions, storage instructions, and processing instructions, among others. The feedback data path 820 can allow instructions within the switching element 812 to be transferred back to the circular buffer. Hence, the instructions 824 and 826 in the switching element 812 can also be transferred back to pipeline stage 0 as the instructions 850 and 852. In addition to the instructions depicted on FIG. 8, a no-op instruction can also be inserted into a pipeline stage. In embodiments, a no-op instruction causes execution to not be performed for a given cycle. In effect, the introduction of a no-op instruction can cause a column within the circular buffer 810 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 858, assuming that the processor q1 was previously in a sleep state. In embodiments, when the instruction 858 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 866. In the case of the instruction 866, data from the processor q1 is moved to the north output. In some embodiments, if Xs have been placed into the processor q1, such as during the instruction 858, then Xs would be retrieved from the processor q1 during the execution of the instruction 866 and would be applied to the north output of the instruction 866.

A collision occurs if multiple instructions route data to a particular port in a given pipeline stage. For example, if instructions 852 and 854 are in the same pipeline stage, they will both send data to the east output at the same time, thus causing a collision since neither instruction is part of a time-multiplexed fan-in instruction (such as the instruction 878). To avoid potential collisions, certain embodiments use preprocessing, such as by a compiler, to arrange the instructions in such a way that there are no collisions when the instructions are loaded into the circular buffer. Thus, the circular buffer 810 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 862), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that calculates the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will ensure that the memory bit is reset to 0, thereby preventing a microDMA controller in the source cluster from sending more data.

Each slave interface manages four interfaces between the FIFOs and the fabric. Each interface can contain up to fifteen data channels. Therefore, a slave should manage read/write queues for up to sixty channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

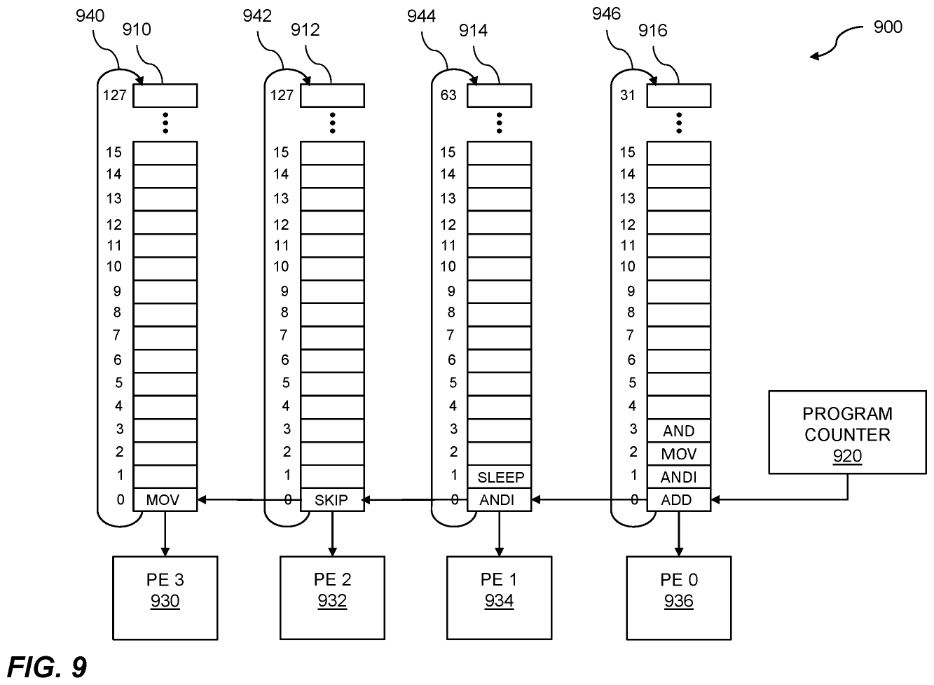

FIG. 9 shows a circular buffer and processing elements. A diagram 900 indicates example instruction execution for processing elements. The processing elements can include a portion of or all of the elements within a reconfigurable fabric. The instruction execution can include FIFO filling logic for tensor calculation. A processor and a memory subsystem for data manipulation are obtained. A FIFO is configured between the processor and the memory subsystem, where the FIFO is coupled with the processor. FIFO filling logic is configured between the FIFO and the memory subsystem, where the FIFO filling logic is connected to the FIFO and the memory subsystem. An element stream from the FIFO is consumed by the processor, where the element stream flows to the FIFO from the memory subsystem through the FIFO filling logic.

A circular buffer 910 feeds a processing element 930. A second circular buffer 912 feeds another processing element 932. A third circular buffer 914 feeds another processing element 934. A fourth circular buffer 916 feeds another processing element 936. The four processing elements 930, 932, 934, and 936 can represent a quad of processing elements. In embodiments, the processing elements 930, 932, 934, and 936 are controlled by instructions received from the circular buffers 910, 912, 914, and 916. The circular buffers can be implemented using feedback paths 940, 942, 944, and 946, respectively. In embodiments, the circular buffer can control the passing of data to a quad of processing elements through switching elements, where each of the quad of processing elements is controlled by four other circular buffers (as shown in the circular buffers 910, 912, 914, and 916) and where data is passed back through the switching elements from the quad of processing elements, where the switching elements are again controlled by the main circular buffer. In embodiments, a program counter 920 is configured to point to the current instruction within a circular buffer. In embodiments with a configured program counter, the contents of the circular buffer are not shifted or copied to new locations on each instruction cycle. Rather, the program counter 920 is incremented in each cycle to point to a new location in the circular buffer. The circular buffers 910, 912, 914, and 916 can contain instructions for the processing elements. The instructions can include, but are not limited to, move instructions, skip instructions, logical AND instructions, logical AND-Invert (i.e. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

In some embodiments, the circular buffers 910, 912, 914, and 916 could all have the same length, for example, 128 instructions. However, in other embodiments, the plurality of circular buffers can have differing lengths. That is, the plurality of circular buffers can comprise circular buffers of differing sizes. As shown in FIG. 9, the first two circular buffers 910 and 912 have a length of 128 instructions, the third circular buffer 914 has a length of 64 instructions, and the fourth circular buffer 916 has a length of 32 instructions, but other circular buffer lengths are also possible. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 9, different circular buffers can have different instruction sets within them. For example, the first circular buffer 910 contains a MOV instruction. The second circular buffer 912 contains a SKIP instruction. The third circular buffer 914 contains a SLEEP instruction and an ANDI instruction. The fourth circular buffer 916 contains an AND instruction, a MOVE instruction, an ANDI instruction, and an ADD instruction. The operations performed by the processing elements 930, 932, 934, and 936 are dynamic and can change over time, based on the instructions loaded into the respective circular buffers. As the circular buffers rotate, new instructions can be executed by the respective processing element.

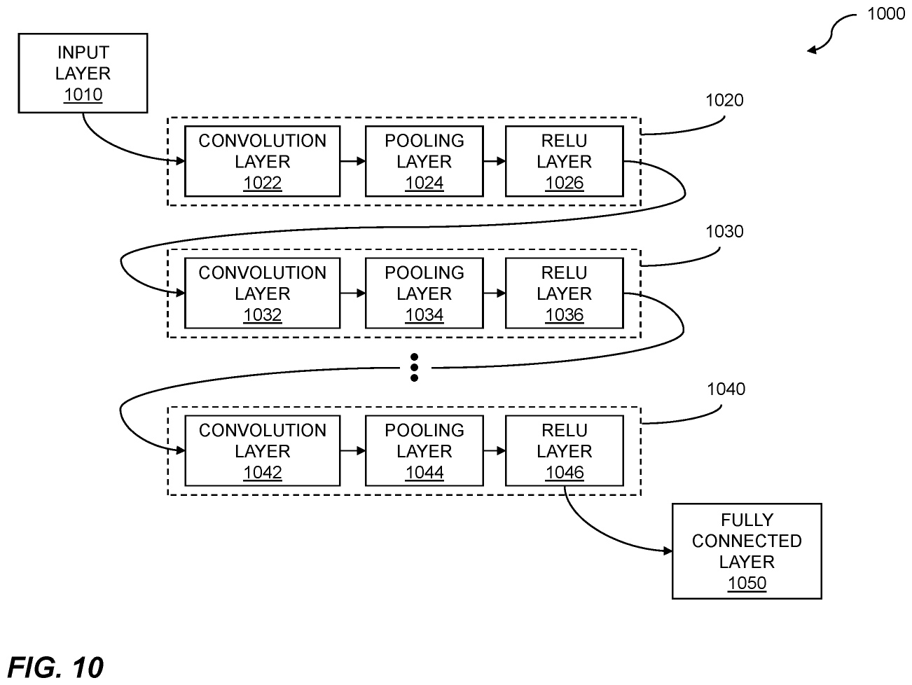

FIG. 10 illustrates a deep learning block diagram. The deep learning block diagram 1000 can include a neural network such as a deep neural network (DNN), a convolutional neural network (CNN), a recurrent neural network (RNN), and so on. A convolutional neural network or other neural network can be based on layers, where the layers can include input layers, output layers, fully connected layers, convolution layers, pooling layers, max pooling layers, rectified linear unit (ReLU) layers, and so on. The layers can include machine learned layers for data manipulation. A neural network can be configured within a reconfigurable fabric. The reconfigurable fabric can include processing elements, switching elements, storage elements, etc. The reconfigurable fabric can be used to perform various operations such as logical operations. Deep learning can support FIFO filling logic for tensor calculation. A processor and a memory subsystem for data manipulation are obtained. A FIFO is configured between the processor and the memory subsystem, where the FIFO is coupled with the processor. FIFO filling logic is configured between the FIFO and the memory subsystem, where the FIFO filling logic is connected to the FIFO and the memory subsystem. The processor consumes an element stream from the FIFO, where the element stream flows to the FIFO from the memory subsystem through the FIFO filling logic

The deep learning block diagram 1000 can include various layers, where the layers can include an input layer, hidden layers, a fully connected layer, and so on. In some embodiments, the deep learning block diagram can include a classification layer. The input layer 1010 can receive input data, where the input data can include a first obtained data group, a second obtained data group, a third obtained data group, a fourth obtained data group, etc. The obtaining of the data groups can be performed in a first locality, a second locality, a third locality, a fourth locality, and so on, respectively. The input layer can then perform processing such as partitioning obtained data into non-overlapping partitions. The deep learning block diagram 1000, which can represent a network such as a convolutional neural network, can contain a plurality of hidden layers. While three hidden layers, hidden layer 1020, hidden layer 1030, and hidden layer 1040 are shown, other numbers of hidden layers may be present. Each hidden layer can include layers that perform various operations, where the various layers can include a convolution layer, a pooling layer, and a rectifier layer such as a rectified linear unit (ReLU) layer. Thus, layer 1020 can include convolution layer 1022, pooling layer 1024, and ReLU layer 1026; layer 1030 can include convolution layer 1032, pooling layer 1034, and ReLU layer 1036; and layer 1040 can include convolution layer 1042, pooling layer 1044, and ReLU layer 1046. The convolution layers 1022, 1032, and 1042 can perform convolution operations; the pooling layers 1024, 1034, and 1044 can perform pooling operations, including max pooling, such as data down-sampling; and the ReLU layers 1026, 1036, and 1046 can perform rectification operations. A convolutional layer can reduce the amount of data feeding into a fully connected layer. The deep learning block diagram 1000 can include a fully connected layer 1050. The fully connected layer can be connected to each data point from the one or more convolutional layers.

Data flow processors can be implemented within a reconfigurable fabric. Data flow processors can be applied to many applications where large amounts of data such as unstructured data is processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PEs). The processing elements can include a processor, a data memory, an instruction memory, communications capabilities, and so on. Multiple PEs can be grouped, where the groups can include pairs, quads, octets, etc. The PEs configured in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0, then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the cluster enters the configuration mode, various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

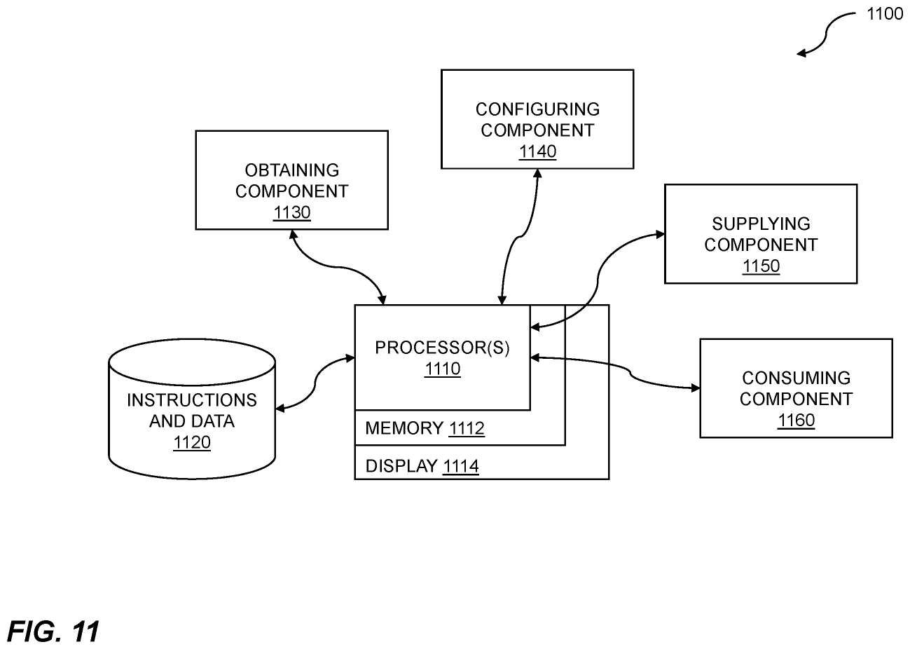

FIG. 11 is a system diagram for data manipulation. Data manipulation is based on first-in first-out (FIFO) filling logic for tensor calculation. The system 1100 can include one or more processors 1110 coupled to a memory 1112 which stores instructions. The system 1100 can include a display 1114 coupled to the one or more processors 1110 for displaying data, intermediate steps, instructions, tensors, and so on. In embodiments, one or more processors 1110 are coupled to the memory 1112 where the one or more processors, when executing the instructions which are stored, are configured to: obtain a processor and a memory subsystem for data manipulation; configure a FIFO between the processor and the memory subsystem, wherein the FIFO is coupled with the processor; configure FIFO filling logic between the FIFO and the memory subsystem, wherein the FIFO filling logic is connected to the FIFO and the memory subsystem; and consume, by the processor, an element stream from the FIFO, wherein the element stream flows to the FIFO from the memory subsystem through the FIFO filling logic. The FIFO is used to feed a data element stream to the processor, where the data elements provide input for a dot product operation. Weights are supplied for the dot product operation through an input path to the processor, different from an input supplied by the FIFO.

The system 1100 can include a collection of instructions and data 1120. The instructions and data 1120 may be stored in storage such as electronic storage coupled to the one or more processors, a database, one or more statically linked libraries, one or more dynamically linked libraries, precompiled headers, source code, flow graphs, kernels, or other suitable formats. The instructions can include instructions for one or more tensor calculations. In embodiments, the tensor calculation can include a tensor convolution function, a tensor max pooling function, and the like. The tensor calculation can be performed within a reconfigurable fabric. The instructions can include satisfiability solver techniques, machine learning or deep learning techniques, neural network techniques, agents, and the like. The instructions can include constraints, routing maps, or satisfiability models. The system 1100 can include an obtaining component 1130. The obtaining component 1130 can include functions and instructions for obtaining a processor and a memory subsystem for data manipulation. The processor and the memory subsystem can be configured within a reconfigurable fabric, where the reconfigurable fabric comprises elements. The elements can include processing elements, storage elements, or switching elements. As discussed throughout, the processor and the memory subsystem can be used to implement graphs, agents, and so on. In embodiments, the processor and memory subsystem can be used to implement a data flow graph. Other types of graphs and nets such as Petri nets, neural networks, and the like can be implemented. In embodiments, the data flow graph can implement machine learning, deep learning, etc. The data flow graph can be partitioned, where the partitions of the data flow graph can include subgraphs, kernels, agents, and the like. In embodiments, the machine learning can utilize one or more neural networks, where the neural networks can include convolutional neural networks, recurrent neural networks, or other neural networks.

The system 1100 can include a configuring component 1140. The configuring component 1140 can include functions and instructions for configuring a FIFO between the processor and the memory subsystem, wherein the FIFO is coupled with the processor. The configuring the FIFO can include setting a size for the FIFO, coupling the FIFO to the processor or to memory, where the memory can include fast memory or slow memory, and so on. Data elements, such as tensor data elements can be stored in the FIFO. The FIFO can be used to buffer data between the fast memory or the slow memory and a processor. The data within the FIFO can include redundant data such as overlapped striding data. In embodiments, the overlapped striding enables redundant data elements to be stored in the FIFO. The overlapped striding data can support redundant data to minimize accesses to fast memory or to slow memory. The configuring component can further include functions and instructions for configuring FIFO filling logic between the FIFO and the memory subsystem, wherein the FIFO filling logic is connected to the FIFO and the memory subsystem. The FIFO filling logic can use an address generator to enable loading of small submatrices of a tensor stored in the memory subsystem into the FIFO for use by the processor. The submatrices can be overlapped submatrices or nonoverlapped submatrices. The FIFO filling logic can provide unique data and non-unique data. In embodiments, the FIFO filling logic provides the FIFO with non-unique elements of the tensor.

The system 1100 can include a supplying component 1150. The supplying component 1150 can include functions and instructions for supplying weights for the dot product operation through an input path to the processor, different from an input supplied by the FIFO. The weights for the dot product can be supplied by uploading by a user, downloading from a library over a computer network, and so on. The supplying weights can be accomplished in parallel with data such as a data element stream to the processor. The weights can be used by the processor and memory subsystem for a neural network. The neural network can be utilized for machine learning. The system 1100 can include a consuming component 1160. The consuming component 1160 can include functions and instructions for consuming, by the processor, an element stream from the FIFO, where the element stream flows to the FIFO from the memory subsystem through the FIFO filling logic. The consuming an element stream can include performing a variety of operations, functions, codes, routines, and so on. The functions, for example, can include logical functions, arithmetic functions, matrix operations, tensor operations, and the like. In embodiments, the consuming can include performing tensor calculations. The tensor calculation can include tensor product, tensor contraction, raising or lowing an index, and so on.

The system 1100 can include a computer program product embodied in a non-transitory computer readable medium for data manipulation, the computer program product comprising code which causes one or more processors to perform operations of: obtaining a processor and a memory subsystem for data manipulation; configuring a FIFO between the processor and the memory subsystem, wherein the FIFO is coupled with the processor; configuring FIFO filling logic between the FIFO and the memory subsystem, wherein the FIFO filling logic is connected to the FIFO and the memory subsystem; and consuming, by the processor, an element stream from the FIFO, wherein the element stream flows to the FIFO from the memory subsystem through the FIFO filling logic. In embodiments, a data manipulation system comprises: a processor; a memory subsystem coupled to the processor; and a FIFO coupled between the processor and the memory subsystem; wherein a FIFO filling logic is configured between the FIFO and the memory subsystem, the FIFO filling logic being coupled to the FIFO and the memory subsystem; said processor consuming an element stream from the FIFO, wherein the element stream flows to the FIFO from the memory subsystem through the FIFO filling logic.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for data manipulation comprising:
obtaining a processor and a memory subsystem for data manipulation;
configuring a FIFO between the processor and the memory subsystem, wherein the FIFO is coupled with the processor;
configuring FIFO filling logic between the FIFO and the memory subsystem, wherein the FIFO filling logic is connected to the FIFO and the memory subsystem; and
consuming, by the processor, an element stream from the FIFO, wherein the element stream flows to the FIFO from the memory subsystem through the FIFO filling logic.

2. The method of claim 1 wherein the element stream from the FIFO comprises elements of a tensor.

3. The method of claim 1 wherein the consuming comprises performing tensor calculations.

4. The method of claim 1 further comprising providing an address to the FIFO filling logic for accessing data from the memory subsystem using an address generator.

5. The method of claim 4 wherein the address generator comprises a second processor.

6. The method of claim 4 wherein the address generator enables memory subsystem access.

7. The method of claim 6 wherein the address generator enables multi-dimensional tensor access by overlapped striding through the multi-dimensional tensor.

8. The method of claim 7 wherein the overlapped striding enables redundant data elements to be stored in the FIFO.

9. The method of claim 7 wherein the overlapped striding enables convolution calculations.

10. The method of claim 7 wherein the overlapped striding enables matrix multiply functionality.

11. The method of claim 4 wherein the FIFO filling logic uses the address generator to enable loading of small submatrices of a tensor stored in the memory subsystem into the FIFO for use by the processor.

12. The method of claim 11 wherein the FIFO filling logic provides the FIFO with non-unique elements of the tensor.

13. The method of claim 4 wherein the address generator enables multi-dimensional tensor access using a FIFO pointer.

14. The method of claim 4 further comprising generating addresses, using the address generator, to access a tensor stored the memory subsystem based on a small N×M submatrix from within the tensor.

15. The method of claim 14 wherein the small N×M submatrix includes N=2 and M=3.

16. The method of claim 14 wherein the small N×M submatrix includes N=2 and M=2.

17. The method of claim 14 wherein elements of the small N×M submatrix are transposed.

18. (canceled)

19. The method of claim 14 wherein elements of the small N×M submatrix are replaced with zeros to indicate validity.

20. The method of claim 14 wherein elements of the small N×M submatrix are replaced with mathematical representations of infinity to indicate validity.

21-23. (canceled)

24. The method of claim 1 wherein the processor executes data-dependent branchless instructions.

25-38. (canceled)

39. The method of claim 1 wherein the processor and memory subsystem are allocated as part of one or more clusters within a reconfigurable fabric.

40. The method of claim 39 wherein each cluster of the one or more clusters within the reconfigurable fabric is controlled by one or more circular buffers.

41-47. (canceled)

48. A computer program product embodied in a non-transitory computer readable medium for data manipulation, the computer program product comprising code which causes one or more processors to perform operations of:
obtaining a processor and a memory subsystem for data manipulation;
configuring a FIFO between the processor and the memory subsystem, wherein the FIFO is coupled with the processor;
configuring FIFO filling logic between the FIFO and the memory subsystem, wherein the FIFO filling logic is connected to the FIFO and the memory subsystem; and
consuming, by the processor, an element stream from the FIFO, wherein the element stream flows to the FIFO from the memory subsystem through the FIFO filling logic.

49. (canceled)

50. A data manipulation system comprising:
a processor;
a memory subsystem coupled to the processor; and
a FIFO coupled between the processor and the memory subsystem, wherein:
a FIFO filling logic is configured between the FIFO and the memory subsystem;
the FIFO filling logic is coupled to the FIFO and the memory subsystem; and
the processor consumes an element stream from the FIFO, wherein the element stream flows to the FIFO from the memory subsystem through the FIFO filling logic.
